(19) United States
(12) Patent Application Publication
(10) Pub. No.: US 2020/0160390 A1
(43) Pub. Date: May 21, 2020

(54) NETWORK USER BEHAVIOR ANALYSIS AND RESULT PRESENTING SYSTEM AND METHOD THEREOF

(71) Applicant: Adbert Tech Media Co., Ltd., Taipei City (TW)

(72) Inventor: Wei-Yu WANG, Taipei City (TW)

(21) Appl. No.: 16/294,108

(22) Filed: Mar. 6, 2019

(30) Foreign Application Priority Data
Nov. 21, 2018 (TW) 107141545

(51) Int. Cl. G06Q 30/02; G06N 20/00; H04L 29/08; H04L 12/26

(52) U.S. Cl. CPC G06Q 30/0256; G06Q 30/0201; H04L 43/045; H04L 67/22; G06N 20/00

(57) ABSTRACT

A network user behavior analysis and result presenting system and a method using the same are disclosed. The network user behavior analysis and result presenting system has an information gathering module and an analysis module. The information gathering module gathers multiple network browsing logs of multiple network users surfing a website. The network browsing logs have a plurality of user characteristic attributes. The analysis module is signally connected to the information gathering module and analyzes the multiple network browsing logs to generate a first analysis result, wherein the first analysis result divides the multiple network users into n sets of customer groups. Each of the n sets of customer groups has m sets of user characteristic attributes, wherein both n, m are natural numbers.

### BACKGROUND OF THE INVENTION

### 1. Field of the Invention

The present invention relates to a network user behavior analysis and result presenting system and a method thereof, particularly to a network user behavior analysis and result presenting system capable of accurately finding loyal consumers and a method thereof for an advertising delivery party to use as a reference to improve the advertising effectiveness.

### 2. Description of the Related Art

With the development and popularity of the Internet, online delivery advertising has become mainstream. However, since the existing network user data analysis only statistically sorts the data of network user characteristic attributes on the website, such as user device type, device location, use period and/or device operating system, the user characteristic attributes data results do not allow the advertising and marketing staff immediately to judge the usage habits or appearance times of advertising customer groups according to statistical data. This is likely to cause misjudgment and increase the advertising delivery cost. Therefore, there is a need for improvement.

### SUMMARY OF THE INVENTION

It is a major objective of the present invention to provide a network user behavior analysis and result presenting system capable of accurately finding loyal consumers for the advertising delivery party reference to improve the advertising effectiveness.

It is another objective of the present invention to provide a network user behavior analysis and result presenting method capable of accurately finding loyal consumers for the advertising delivery party reference to improve the advertising effectiveness.

To achieve the above objectives, the network user behavior analysis and result presenting system of the present invention includes an information gathering module and an analysis module. Specifically, the information gathering module gathers multiple network browsing logs of multiple network users surfing a website. The multiple network browsing logs include a plurality of user characteristic attributes. The analysis module is signally connected to the information gathering module and analyzes the multiple network browsing logs to generate a first analysis result. It is characterized in that: the first analysis result divides multiple network users into n sets of customer groups. Each of the n sets of customer groups has m sets of user characteristic attributes, wherein both n, m are natural numbers.

The present invention further provides a network user behavior analysis and result presenting method, which includes the following steps: gathering multiple network browsing logs of multiple network users surfing at least one website, wherein the multiple network browsing logs include a plurality of user characteristic attributes; analyzing the multiple network browsing logs to generate a first analysis result, characterized in that: the first analysis result divides the multiple network users into n sets of customer groups. Each of the n sets of customer groups has m sets of user characteristic attributes, wherein both n, m are natural numbers.

The first analysis result generated by the network user behavior analysis and the result presenting system of the present invention allows the advertising delivery party to clearly know the user characteristic attributes, the total number of customer groups and the webpage interaction indicators of loyal consumers. Accordingly, the advertisement delivery party can find out the activity times and characteristic attributes of the loyal consumers on the website to improve the advertising effectiveness.

### BRIEF DESCRIPTION OF THE DRAWINGS

FIG. 1 is a block diagram of a network user behavior analysis and result presenting system in an embodiment of the present invention;

FIG. 2 is a schematic view showing the first analysis result of the network user behavior analysis and result presenting system in an embodiment of the present invention;

FIG. 3 is a schematic view showing the second analysis result of the network user behavior analysis and result presenting system in an embodiment of the present invention;

FIG. 4 is a radar chart of the network user behavior analysis and result presenting system in an embodiment of the present invention;

FIG. 5 is a block diagram of the network user behavior analysis and result presenting system in an embodiment of the present invention;

FIG. 6 is a bubble chart of the network user behavior analysis and result presenting system in an embodiment of the present invention;

FIG. 7 is a flowchart showing steps of a network user behavior analysis and result presenting method in a first embodiment of the present invention; and

FIG. 8 is a flowchart showing steps of a network user behavior analysis and result presenting method in a second embodiment of the present invention.

### DETAILED DESCRIPTION OF THE PREFERRED EMBODIMENT

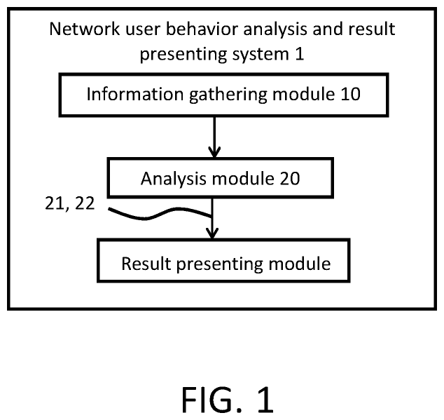

Hereafter, the technical content of the present invention will be better understood with reference to preferred embodiments. Please refer to FIGS. 1 to 6 regarding block diagrams of a network user behavior analysis and result presenting system of the present invention, schematic views of the first analysis result in an embodiment of the present invention, schematic views of the second analysis result in an embodiment of the present invention, and a radar chart, a block diagram, and a bubble chart of the network user behavior analysis and result presenting system in an embodiment of the present invention.

As shown in FIG. 1, in the present embodiment, the network user behavior analysis and result presenting system 1 of the present invention includes an information gathering module 10, an analysis module 20, and a result presenting module 30. Specifically, the information gathering module 10 gathers multiple network browsing logs of multiple network users surfing a website through tracking codes embedded in each website. The multiple network browsing logs include multiple webpage interaction indicators 130 and user characteristic attributes 110. Specifically, the webpage interaction indicators 130 include average working period, average stay time and/or average number of pages viewed, etc. The user characteristic attributes 110 include user device type, device location, use period and/or device operating system, etc. However, gathering multiple network browsing logs of multiple network users surfing a website through tracking codes embedded in each website is the prior art, and thus the details are not described.

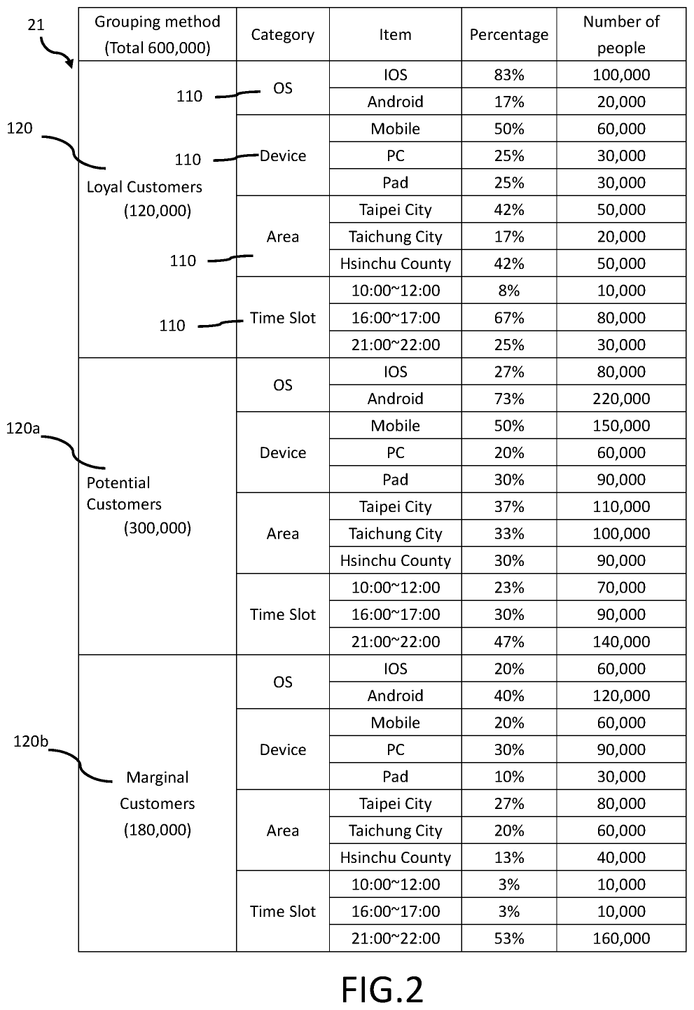

The analysis module 20 is signally connected to the information gathering module 10. In the present embodiment, the analysis module 20 analyzes the multiple network browsing logs with machine learning algorithms to generate a first analysis result. It is characterized in that: the first analysis result 21 divides the multiple network users into n sets of customer groups. Each of the n sets of customer groups includes m sets of user characteristic attributes, wherein both n, m are natural numbers. According to an embodiment of the present invention, 1≤n≤100; 1≤m≤100, and each of the n sets of customer groups includes the total number of customer groups. As shown in FIG. 2, in the present embodiment, n=3, m=4. The first analysis result 21 includes 3 sets of customer groups (loyal customers, potential customers and marginal customers). Each of the customer groups includes 4 sets of user characteristic attributes 110 (user device type, device location, use period and/or device operating system). The total number of online users analyzed this time is 600,000, wherein the number of loyal customers is 120,000 (the total number of customer groups 120), the number of potential customers is 300,000 (the total number of customer groups 120a), and the number of marginal customers is 180,000 (the total number of customer groups 120b). From the first analysis result 21, the advertising and marketing staff can immediately find the user characteristic attributes 110 of loyal customers and loyal customers from the total number of 600,000 network users in the first analysis result 21. For example, for the most common time and region, the advertising and marketing staff can develop advertising delivery strategies and times that can reach the most loyal customers to achieve accurate delivery and improve the advertising effectiveness. It should be noted here that the machine learning algorithm is a commonly used algorithm for artificial intelligence, and thus the details are not described.

It should be noted that the generation of a first analysis result by the analysis module 20 analyzing the multiple network browsing logs with machine learning algorithms is merely one of the embodiments of the present invention. The analysis module 20 of the present invention may generate a first analysis result by analyzing multiple network browsing logs according to a pre-defined classification rule. For example, as specified in the classification rules, in accordance with the average stay time and the average number of pages viewed of multiple network users on a website, the top 10% of the average stay time and the average number of pages viewed of the total customer groups are loyal customers, the bottom 30% of the average stay time and the average number of pages viewed of the total customer groups are marginal customers, and the middle 60% are potential customers. For example, a user who has an average stay time of 5 minutes and an average number of pages viewed of pages is a loyal customer, a user who has an average stay time of less than 1 minute and an average number of pages viewed of less than 1 page is a marginal customer, and a user who has an average stay time of more than 1 minute but less than 5 minutes and an average number of pages viewed of more than 1 page but less than 3 pages is a potential customer. It should be noted here that the analysis method that the analysis module can use is not limited to the above embodiment.

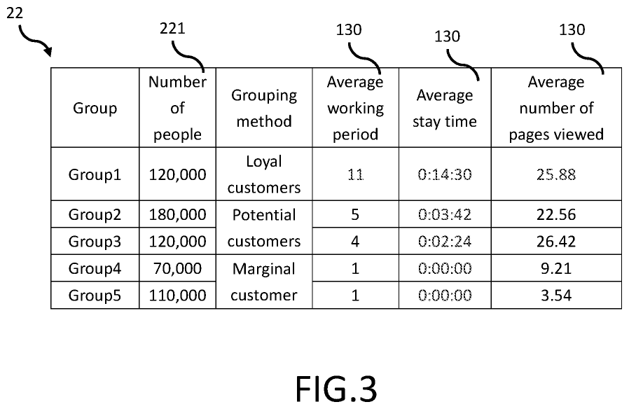

Further, as shown in FIG. 1 and FIG. 3, according to an embodiment of the present invention, before the analysis module 20 generate the first analysis result 21, the analysis module 20 analyzes the multiple webpage interaction indicators 130 with machine learning algorithms to generate a second analysis result 22. It is characterized in that: the second analysis result 22 divides the multiple network users into p sets of subgroups. Each of the p sets of subgroups includes y sets of webpage interaction indicators 130, wherein both p, y are natural numbers. As shown in FIG. 3, in the present embodiment, p=5, y=3, so the second analysis result 22 includes 5 subgroups (groups 1-5). Each of the customer groups includes 3 sets of webpage interaction indicators 130 (the average working period, average stay time and average number of pages viewed), where the total number of subgroups 221 of group 1 is 120,000, because compared to other subgroups (groups 2-5), the webpage interaction indicators 130 of the Network users in group 1 has the highest consistency with the website, so the subgroup (group 1) is loyal customers. In the present embodiment, groups 2-3 are potential customers, and groups 4-5 are marginal customers. It should be noted here that there is no correspondence between the number of subgroups in the second analysis result 22 and the number of customers in the first analysis result 21. The system developer sets the number of subgroups and the number of customer groups and classification criteria according to different products or advertisement types, which is not limited to the present embodiment.

It should be noted here that that the generation of a second analysis result by the analysis module 20 analyzing the multiple network browsing logs with machine learning algorithms is merely one of the embodiments of the present invention. The analysis module 20 of the present invention may generate a second analysis result by analyzing multiple network browsing logs according to a pre-defined classification rule. For example, as specified in the classification rules, in accordance with the average stay time and the average number of pages viewed of multiple network users on a website, the top 10% of the average stay time and the average number of pages viewed of the total customer groups are a subgroup (group 1), the bottom 10% of the average stay time and the average number of pages viewed of the total customer groups are another subgroup (group 5), and the bottom 10-20% of the average stay time and the average number of pages viewed of the total customer groups are a subgroup (group 4). The middle 60% is divided into two subgroups (group 2 and group 3) based on individual average stay time and average number of pages viewed. For example, a user who has an average stay time of 5 minutes and an average number of pages viewed of 25 pages belongs to a subgroup (group 1), a user who has an average stay time of less than 1 minute and an average number of pages viewed of less than 10 pages belongs to one of two subgroups (group 5 and group 4), and a user who has an average stay time for more than 1 minute but less than 5 minutes and an average number of pages viewed of more than 1 page but less than 25 pages belongs to one of two subgroups (group 2 and group 3). It should be noted here that the analysis method that the analysis module can use is not limited to the above embodiment.

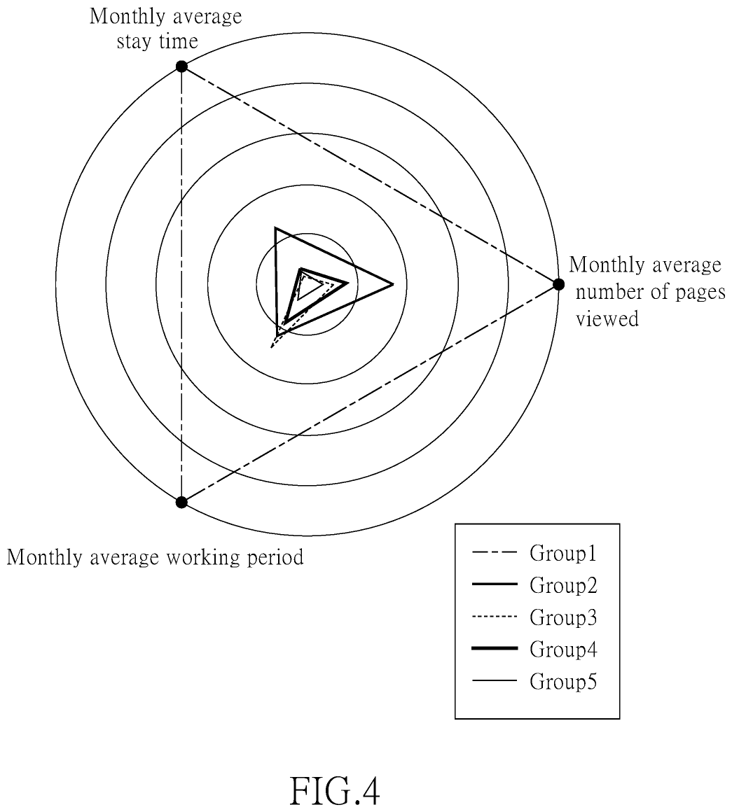

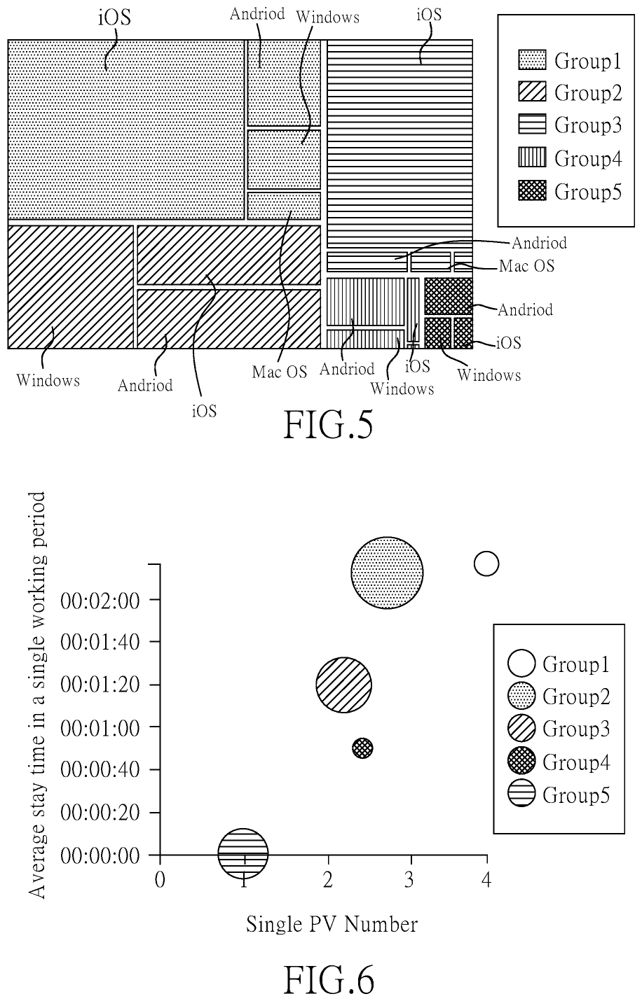

As shown in FIG. 1 and FIG. 2, the result presenting module is signally connected to the classifying module 20. In the present embodiment, the result presenting module 30 presents the first analysis result 21 in table form, but the present invention is not limited thereto. The result presenting module 30 may present the first analysis result 21 in a graph/chart form. Specifically, the graph/chart forms include a table (as shown in FIG. 2 or FIG. 3), a radar chart (as shown in FIG. 4), a street map (as shown in FIG. 5) and/or a bubble chart (as shown in FIG. 6). As shown in FIG. 1, the network user behavior analysis and result presenting system 1 of the present invention may be, for example, one or several computer servers, including an information gathering module 10, a classifying module 20, and a result presenting module 30. It should be noted that the above respective modules may not only be configured as hardware devices, software programs, firmware, or combinations thereof, but configured by circuit loop or other suitable types; also, each of the modules can be configured individually or in the form of combination. In a preferred embodiment, each module is stored in a software program, and each module is executed by a processor (not shown) in the network user behavior analysis and result presenting system 1 to achieve the function of the present invention. Additionally, the preferred embodiment of the present invention described here is only illustrative. To avoid redundancy, not all the possible combinations of changes are documented in detail. However, it shall be understood by those skilled in the art that each of the modules or elements described above may not be necessary. For the implementation of the present invention, the present invention may also contain other detailed, conventional modules or elements. Each module or component is likely to be omitted or modified depending on the needs of the user. Other modules or elements may not necessarily exist between any two of any modules.

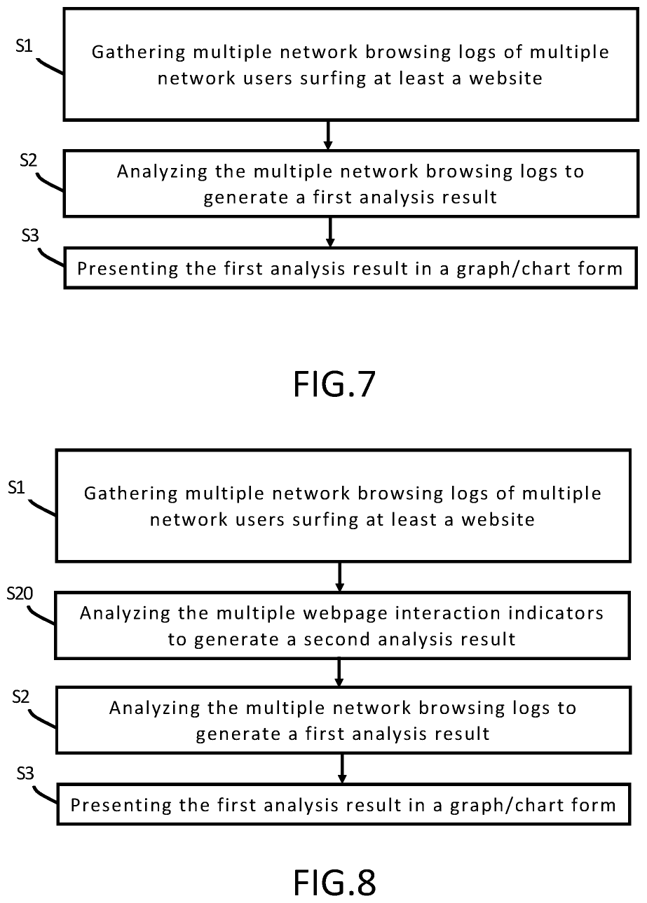

Hereafter, please continue to refer to FIGS. 1 to 6, and FIG. 7 as well. Specifically, FIG. 7 is a flowchart showing steps of the network user behavior analysis and result presenting method in the first embodiment of the present invention.

The network user behavior analysis and result presenting method of the present invention, as shown in FIG. 1, is applied to the network user behavior analysis and result presenting system 1. As shown in FIG. 7, the network user behavior analysis and result presenting method of the present invention includes Step S1 to Step S3. Hereafter, each step of the network user behavior analysis and result presenting method in the first embodiment of the present invention will be described in detail.

Step S1: Gathering multiple network browsing logs of multiple network users surfing at least a website.

The information gathering module 10 gathers multiple network browsing logs of multiple network users surfing a website through tracking codes embedded in each website. The multiple network browsing logs include multiple webpage interaction indicators 130 and user characteristic attributes 110. Specifically, the webpage interaction indicators 130 include the average working period, average stay time and/or average number of pages viewed, etc. The user characteristic attributes 110 include the user device type, device location, use period and/or device operating system, etc. However, gathering multiple network browsing logs of multiple network users surfing a website through tracking codes embedded in each website is the prior art, and thus the details are not described herein.

Step S2: Analyzing the multiple network browsing logs to generate a first analysis result.

The analysis module 20 is signally connected to the information gathering module 10. The analysis module 20 analyzes the multiple network browsing logs with machine learning algorithms to generate a first analysis result. It is characterized in that: the first analysis result 21 divides the multiple network users into n sets of customer groups. Each of the n sets of customer groups includes m sets of user characteristic attributes, wherein both n, m are natural numbers. According to an embodiment of the present invention, 1≤n≤100; 1≤m≤100. Each of the n sets of customer groups includes a total number of customer groups. As shown in FIG. 2, in the present embodiment, n=3, m=4. The first analysis result 21 includes 3 sets of customer groups (loyal customers, potential customers and marginal customers). Each of the customer groups includes 4 sets of user characteristic attributes (user device type, device location, use period and/or device operating system). The total number of online users analyzed this time is 600,000, wherein the number of loyal customers is 120,000 (the total number of customer groups 120), the number of potential customers is 300,000 (the total number of customer groups 120a), and the number of marginal customers is 180,000 (the total number of customer groups 120b). From the first analysis result 21, the advertising and marketing staff can immediately identify the user characteristic attributes 110 of loyal customers and loyal customers from the total number of 600,000 network users in the first analysis result 21. For example, for the most common time and region, the advertising and marketing staff can develop advertising delivery strategies and times that can reach the most loyal customers to achieve accurate delivery and improve the advertising effectiveness. It should be noted here that the machine learning algorithm is a commonly used algorithm for artificial intelligence, and thus the details are not described herein.

It should be noted that that the generation of a first analysis result by the analysis module 20 analyzing the multiple network browsing logs with machine learning algorithms is merely one of the embodiments of the present invention. The analysis module 20 of the present invention may generate a first analysis result by analyzing multiple network browsing logs according to a pre-defined classification rule. For example, as specified in the classification rules, in accordance with the average stay time and the average number of pages viewed of multiple network users on a website, the top 10% of the average stay time and the average number of pages viewed of the total customer groups are loyal customers, the bottom 30% of the average stay time and the average number of pages viewed of the total customer groups are marginal customers, and the middle 60% are potential customers. For example, a user who has an average stay time of 5 minutes and an average number of pages viewed of pages is a loyal customer, a user who has an average stay time of less than 1 minute and an average number of pages viewed of less than 1 page is a marginal customer, and a user who has an average stay time of more than 1 minute but less than 5 minutes and an average number of pages viewed of more than 1 page but less than 3 pages is a potential customer. It should be noted here that the analysis method that the analysis module can use is not limited to the above embodiment.

Step S3: Presenting the first analysis result in a graph/chart form.

As shown in FIG. 1 and FIG. 2, the result presenting module is signally connected to the classifying module 20. In the present embodiment, the result presenting module 30 presents the first analysis result 21 in a table, but the present invention is not limited thereto. The result presenting module 30 may present the first analysis result 21 in a graph/chart form. Specifically, the graph/chart form includes a table (as shown in FIG. 2 or FIG. 3), a radar chart (as shown in FIG. 4), a street map (as shown in FIG. 5) and/or a bubble chart (as shown in FIG. 6).

Hereafter, please refer to FIGS. 1 to 6, and FIG. 8 as well. Specifically, FIG. 8 is a flowchart showing steps of the network user behavior analysis and result presenting method in the second embodiment of the present invention. As shown in FIG. 8, the difference between the network user behavior analysis and result presenting method in the second embodiment and that in the first embodiment of the present invention is that, in the second embodiment of the present invention, the network user behavior analysis and result presenting method of the present invention further includes Step S20. Hereafter, the details of Step S20 will be described.

Step S20: Analyzing multiple webpage interaction indicators to generate a second analysis result.

As shown in FIG. 1 and FIG. 3, according to an embodiment of the present invention, before the analysis module 20 generates the first analysis result 21, the analysis module 20 analyzes the multiple webpage interaction indicators 130 with machine learning algorithms to generate a second analysis result 22. It is characterized in that: the second analysis result 22 divides the multiple network users into p sets of subgroups. Specifically, each of the p sets of subgroups includes y sets of webpage interaction indicators 130, wherein both p, y are natural numbers. As shown in FIG. 3, in the present embodiment, p=5, y=3, the second analysis result 22 includes 5 sets of subgroups (groups 1-5). Each of the customer groups includes 3 sets of webpage interaction indicators 130 (the average working period, average stay time and average number of pages viewed). Specifically, the total number of subgroups 221 of group 1 is 120,000. Compared with other subgroups (groups 2-5), the webpage interaction indicators 130 of the network users in group 1 has the highest consistency with the website, so the subgroup (group 1) is loyal customers. In the present embodiment, groups 2-3 are potential customers, and groups 4-5 are marginal customers. It should be noted here that the number of subgroups in the second analysis result 22 does not correspond to the number of customers in the first analysis result 21. The system developer sets the number of subgroups and the number of customer groups and classification criteria according to different products or advertisement types, which is not limited to the present embodiment.

It should be noted that that the generation of a second analysis result by the analysis module 20 analyzing the multiple network browsing logs with machine learning algorithms is merely one of the embodiments of the present invention. The analysis module 20 of the present invention may generate a second analysis result by analyzing multiple network browsing logs according to a pre-defined classification rule. For example, as specified in the classification rules, in accordance with the average stay time and the average number of pages viewed of multiple network users on a website, the top 10% of the average stay time and the average number of pages viewed of the total customer groups belong to a subgroup (group 1), the bottom 10% of the average stay time and the average number of pages viewed of the total customer groups belong to another subgroup (group 5), and the bottom 10-20% of the average stay time and the average number of pages viewed of the total customer groups are a subgroup (group 4). The middle 60% is divided into two subgroups (group 2 and group 3) according to individual average stay time and average number of pages viewed. For example, a user who has an average stay time of 5 minutes and an average number of pages viewed of 25 pages belongs to a subgroup (group 1), a user who has an average stay time of less than 1 minute and an average number of pages viewed of less than 10 pages belongs to one of two subgroups (group 5 and group 4), and a user who has an average stay time of more than 1 minute but less than 5 minutes and an average number of pages viewed of more than 1 page but less than 25 pages belongs to one of two subgroups (group 2 and group 3). It should be noted here that the analysis method that the analysis module 20 can use is not limited to the above embodiment.

Through multiple network browsing logs, the network user behavior analysis and result presenting system and method thereof of the present invention can find loyal customers who are most attracted to the websites from the multiple network users and provide marketing staff with intuitive data reports to achieve accurate delivery and improve the advertising effectiveness, while eliminating the time for the marketing staff to analyze the gold delivery advertising time.

It should be noted that the described embodiments are only for illustrative and exemplary purposes, and that various changes and modifications may be made to the described embodiments without departing from the scope of the invention as described by the appended claims.

What is claimed is:

1. A network user behavior analysis and result presenting system, comprising:
an information gathering module, which is used for gathering multiple network browsing logs of multiple network users surfing a website, wherein the multiple network browsing logs includes a plurality of user characteristic attributes; and
an analysis module signally connected to the information gathering module, which analyzes the multiple network browsing logs to generate a first analysis result and is characterized in that: the first analysis result divides the multiple network users into n sets of customer groups, and each of the n sets of customer groups includes m sets of user characteristic attributes, wherein both n, m are natural numbers.

2. The network user behavior analysis and result presenting system as claimed in claim 1, further comprising a result presenting module signally connected to the classifying module, wherein the result presenting module presents the first analysis result in a graph/chart form, wherein the graph/chart form includes a table, a radar chart, a street map, and/or a bubble chart.

3. The network user behavior analysis and result presenting system as claimed in claim 1, wherein the multiple network browsing logs include a plurality of webpage interaction indicators, and before the analysis module generates the first analysis result, the analysis module analyzes the multiple webpage interaction indicators to generate a second analysis result, characterized in that: the second analysis result divides the multiple network users into p sets of subgroups, and each of the p sets of subgroups includes y sets of webpage interaction indicators, wherein both p, y are natural numbers.

4. The network user behavior analysis and result presenting system as claimed in claim 3, further comprising a result presenting module signally connected to the classifying module, wherein the result presenting module presents the first analysis result in a graph/chart form, wherein the graph/chart form includes a table, a radar chart, a street map, and/or a bubble chart.

5. The network user behavior analysis and result presenting system as claimed in claim 3, wherein the multiple webpage interaction indicators include the average working period, average stay time and/or average number of pages viewed.

6. The network user behavior analysis and result presenting system as claimed in claim 5, further comprising a result presenting module signally connected to the classifying module, wherein the result presenting module presents the first analysis result in a graph/chart form, wherein the graph/chart form includes a table, a radar chart, a street map, and/or a bubble chart.

7. The network user behavior analysis and result presenting system as claimed in claim 1, wherein the plurality of user characteristic attributes include the user device type, device location, use period and/or device operating system, and each of the n sets of customer groups includes a total number of customer groups.

8. The network user behavior analysis and result presenting system as claimed in claim 7, further comprising a result presenting module signally connected to the classifying module, wherein the result presenting module presents the first analysis result in a graph/chart form, wherein the graph/chart form includes a table, a radar chart, a street map, and/or a bubble chart.

9. A network user behavior analysis and result presenting method, comprising the following steps:
gathering multiple network browsing logs of multiple network users surfing a website, wherein the multiple network browsing logs include a plurality of user characteristic attributes;
analyzing the multiple network browsing logs to generate a first analysis result, which is characterized in that: the first analysis result divides the multiple network users into n sets of customer groups, and each of the n sets of customer groups has m sets of user characteristic attributes and a total number of customer groups, wherein both n, m are natural numbers.

10. The network user behavior analysis and result presenting method as claimed in claim 9, further comprising the following step: presenting the first analysis result in a graph/chart form, wherein the graph/chart form includes a table, a radar chart, a street map and/or a bubble chart.

11. The network user behavior analysis and result presenting method as claimed in claim 9, wherein the multiple network browsing logs include multiple webpage interaction indicators, and before generating the first analysis result, the network user behavior analysis and result presenting method comprises the following steps:
analyzing the multiple webpage interaction indicators to generate a second analysis result, characterized in that:
the second analysis result divides the multiple network users into p sets of subgroups, and each of the p sets of subgroups includes y sets of webpage interaction indicators, wherein both p, y are natural numbers.

12. The network user behavior analysis and result presenting method as claimed in claim 11, further comprising the following step:
presenting the first analysis result in a graph/chart form, wherein the graph/chart form includes a table, a radar chart, a street map and/or a bubble chart.

13. The network user behavior analysis and result presenting method as claimed in claim 11, wherein the multiple webpage interaction indicators include the average working period, average stay time and/or average number of pages viewed.

14. The network user behavior analysis and result presenting method as claimed in claim 13, further comprising the following step:
presenting the first analysis result in a graph/chart form, wherein the graph/chart form includes a table, a radar chart, a street map and/or a bubble chart.

15. The network user behavior analysis and result presenting method as claimed in claim 9, wherein the plurality of user characteristic attributes include user device type, device location, use period and/or device operating system, and each of the n sets of customer groups includes a total number of customer groups.

16. The network user behavior analysis and result presenting method as claimed in claim 15, further comprising the following step:
presenting the first analysis result in a graph/chart form, wherein the graph/chart form includes a table, a radar chart, a street map and/or a bubble chart.
